(19) United States
(12) Patent Application Publication
(10) Pub. No.: US 2022/0030919 A1
(43) Pub. Date: Feb. 3, 2022

(54) Perishable Storage Unit with Means for Sanitizing Food Stuffs

(71) Applicant: Peter Bofill, Opa Locka, FL (US)

(72) Inventor: Peter Bofill, Opa Locka, FL (US)

(21) Appl. No.: 16/943,979

(22) Filed: Jul. 30, 2020

(51) Int. Cl. A23L 3/28; A23L 3/00; F25D 23/12

(52) U.S. Cl. CPC A23L 3/28; A23L 3/003; A23V 2002/00; F25D 23/12; A23L 3/001

(57) ABSTRACT

A perishable storage unit with means for sanitizing food stuffs having a sanitization unit. The storage unit provides a storage body, a door, and a cooling system, wherein the cooling system is integrated with the storage body to maintain a cooling temperature when the door is in a closed position. The sanitization unit includes a light assembly and a switch, wherein the switch is integrated with a peripheral edge of the storage unit such that the door engages the switch when in the closed position. The light assembly is configured to emit sterilizing wavelengths of light, such as ultraviolet light, and is operably coupled to the switch, such that when the door is actuated from an open position to the closed position, the light assembly is switched from an off state to an on state.

### CROSS-REFERENCES TO RELATED APPLICATIONS

None.

### . STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field Of The Invention

The present invention relates to food storage, and more particularly, to an improved device and method for sanitizing perishables in a cooled storage unit.

### 2. Description of Related Art Including Information Disclosed Under 37 CFR 1.97 and 37 CFR 1.98

Several designs for perishable storage units have been designed in the past. None of them, however, includes means for sanitizing food stuffs placed within the storage unit.

Other patents and prior art that relate to the subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

It is one of the main objects of the present invention to provide a perishable storage unit.

It is another object of this invention to provide a perishable storage unit which has a means for sanitizing food stuffs that are placed within the storage unit.

It is still another object of the present invention to provide a perishable storage unit that is energy efficient, wherein means are provided for regulating the duration of a sanitization program is deployed.

It is yet another object of this invention to provide such a perishable storage unit that is inexpensive to manufacture and maintain while retaining its effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 shows a front right perspective view of a storage unit with a door in an open position, wherein the door is disengaged from a switch controlling a light assembly within the storage unit.

FIG. 2 shows a top sectional view along line A-A of FIG. 1, wherein the hinged motion of the door to engage and disengage with the switch is indicated by a dashed line.

### DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject perishable storage unit with means for sanitizing food stuffs is sometimes referred to as the device, the invention, the refrigerator, the storage unit, the machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Referring now to the drawings, where the present invention is generally referred to with numeral 10, it can be observed that it basically includes a sanitization unit 20 inside the storage body 12. The sanitization unit 20 is intended to maintain a cooling temperature such that the perishable life of food stuffs placed therein is prolonged and generally comprises a cooling system 11, a storage body 12, and a door 14. Meanwhile, the sanitization unit 20 is intended to sterilize the food stuffs, and their accompanying packaging, when placed within the device. The sanitization unit 20 generally comprises a light assembly 21 and a switch 22 and may further include a means for regulating actuation of the light assembly 21.

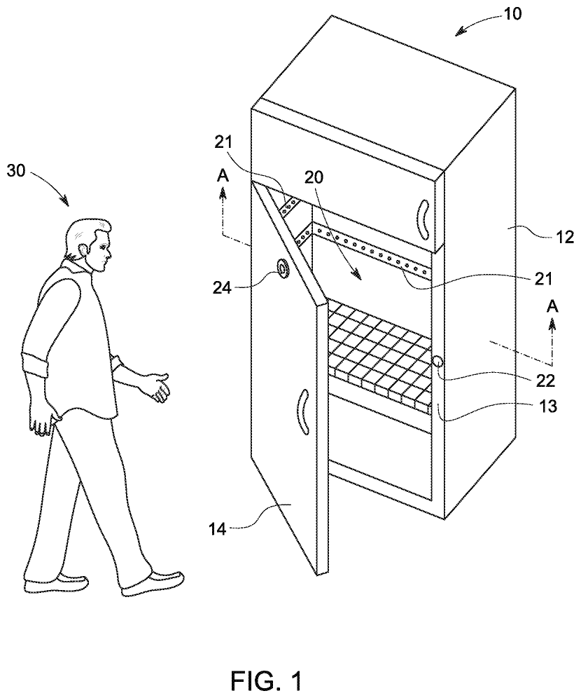

In reference to FIG. 1, the storage body 12 is a walled structure with a closed end and an open end, wherein food stuffs may be placed in or retrieved from the storage body 12 through the open end. The storage body 12 is configured to keep items placed therein at the cooling temperature to prolong their perishable life. As such, the walls of the storage body 12 may be insulated to assist in regulating the cooling temperature within the storage body 12 and to increase the thermal efficiency of the storage unit 10. In some embodiments, the storage body 12 may further include organizational means, such as shelves or drawers, for arranging food stuffs within the storage body 12.

In further reference to FIG. 1, the door 14 is hinged to the storage body 12 such that the door 14 may be pivoted between a closed position and an open position. More specifically, the door 14 is hinged to a peripheral edge 13 of the storage body 12, wherein the peripheral edge 13 forms the open end of the storage body 12. In the closed position, the door 14 covers the open end of the storage body 12 to form an enclosed space. The door 14 can be pivoted to the open position to place items within or retrieve items from the storage body 12. A sealing mechanism, such as a rubber strip, may be integrated into one or both of the door 14 and the storage body 12 to increase the thermal efficiency of the storage unit 10. Similar to the storage body 12, the door 14 may be insulated to assist in regulating the temperature within the storage body 12 and increase thermal efficiency. In some embodiments, the door 14 may further include organizational means, such as shelves or drawers, for arranging food stuffs about the side of the door 14 adjacent to the storage body 12.

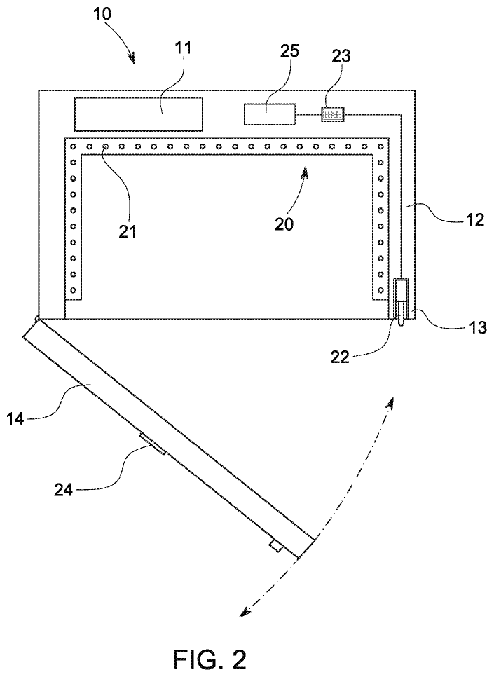

In reference to FIG. 2, the cooling system 11 is integrated into the storage body 12. The cooling system 11 may comprise components similar to those commonly found in refrigerators or freezers, wherein the cooling system 11 is configured to maintain a cooling temperature within the storage body 12 when the door 14 is in the closed position. In the preferred embodiment, the cooling temperature is between 0° F. and 40° F. However, in other embodiments the cooling temperature may be less than or equal to 0° F. or greater than or equal to 40° F. For example, to freeze the contents it may be colder.

The cooling system 11 may comprise a control mechanism that allows a user to adjust the cooling temperature. The control mechanism may be positioned within the storage body 12, outside the storage body 12, or be integrated with the door 14. In some embodiments, the control mechanism may be a dial or potentiometer within the storage body 12, wherein the user can turn the control mechanism to set the cooling temperature. In other embodiments, the control mechanism may be a touch screen or button panel integrated into the exterior of the door 14, wherein the user can set the cooling temperature without opening the door 14. In yet other embodiments, the control mechanism may be a wireless transceiver, wherein the user can set the cooling temperature from a remote device, such as a smartphone.

In reference to FIG. 1, the sanitization unit 20 is integrated with the storage body 12 such that food stuffs and their accompanying packaging may be sterilized when placed within the storage unit 10. The light assembly 21 may be integrated with one or both of the door 14 and the storage body 12 and is configured to emit sterilizing wavelengths of light, such as ultraviolet light. In the preferred embodiment of the present invention, the light assembly 21 is configured to emit ultraviolet light which is the best-known wavelength for effectively performing germicidal irradiation. However, different wavelengths may be used in other embodiments as the different wavelengths may be found to be more effective depending on the items to be sterilized, the type of pathogen or the cooling temperature of the storage unit 10.

In one embodiment, the light assembly 21 comprises a single bulb that is retained within a mount or socket. The single bulb is powerful enough to illuminate the entire interior of the storage unit 10 such that food stuffs placed anywhere within the storage unit 10 are safely irradiated. In another embodiment, the light assembly 21 comprises a plurality of light strips, wherein each of the plurality of light strips includes a housing and one or more light emitting diodes. One or more of the plurality of light strips may be positioned along the door 14 and each wall of the storage body 12 such that light is emitted from each interior side of the storage unit 10, ensuring full light coverage within the storage unit 10. Furthermore, one or more of the plurality of light strips may be positioned within the drawers of the door 14 or the storage body 12 and on the shelves of the door 14 or the storage body 12.

In some embodiments of the present invention, the interior of the storage unit 10 may further comprise one or more reflective surfaces. The reflective surfaces are integrated about the interior of the door 14 and the storage body 12 such that they reflect the light emitted by the light assembly 21. In this way, the number of lighting elements of the light assembly 21 may be reduced, which in effect reduces energy consumption and may reduce manufacturing costs.

The light assembly 21 is electrically connected to the switch 22 as shown in FIG. 2, wherein the switch 22 toggles the light assembly 21 between an on state and an off state. The switch 22 is integrated with the peripheral edge 13 of the storage body 12 such that the door 14 engages the switch 22 when the door 14 is in the closed position. When the door 14 is moved from the open position to the closed position such that the door 14 engages the switch 22, the light assembly 21 is toggled to on state. Subsequently, when the door 14 is moved from the closed position to the open position such that the door 14 disengages the switch 22, the light assembly 21 is toggled to the off state so as to not shine onto the user of the device.

In one embodiment, the switch 22 is a biased switch. When the door 14 engages the switch 22, the switch 22 is pushed into a set position closing the electrical circuit and the light assembly 21 is powered to the on state. When the door 14 disengages the switch 22, the switch 22 is biased out of the set position by, for example, a spring force, wherein the circuit is broken and the light assembly 21 is switched to the off state. In another embodiment, the switch 22 is an electromagnetic switch, wherein an electromagnet is integrated into the door 14 and the switch 22 is normally open. When the electromagnet is positioned adjacent to the switch 22, the circuit closes and the light assembly 21 is powered to the on state. In yet another embodiment, the switch 22 is a magnetic switch, wherein a magnet is integrated into the door 14. When the magnet is positioned adjacent to the switch 22, the circuit closes and the light assembly 21 is powered to the on state. While the above embodiments of the switch 22 have been provided, it is to be known that any other suitable type of switch 22 may be used for toggling the light assembly 21 between the on state and the off state.

In reference to FIG. 2, the sanitization unit 20 may further comprises a timer 23 to limit the duration for which the light assembly 21 is switched to the on state and thus increase the energy efficiency of the present invention. The timer 23 is electrically connected with the light assembly 21 such that the timer 23 breaks the circuit after a preset time in order to toggle the light assembly 21 to the off state. In some embodiments the timer 23 may be integrated with the switch 22, wherein the timer 23 flips the switch 22 in order to break the circuit. In other embodiments, the timer 23 may have its own independent means for breaking the circuit. For example, the light may be kept on for a few minutes or a few hours to complete the sanitation cycle. These times could be less or more depending on the contents, the pathogen and the power of the light contacting the contents being sanitized.

In further reference to FIG. 2, the sanitization unit 20 may further comprise an external sensor 24 and a processing unit 25, wherein the processing unit 25 is electronically connected to the external sensor 24 and the light assembly 21. The external sensor 24 and the processing unit 25 are configured to detect the presence of a human 30. When the presence of the human 30 is detected, the processing unit 25 toggles the light assembly 21 to the off state. In this way, the human 30 is not exposed to the ultraviolet light of the light assembly 21.

In one embodiment the external sensor 24 is integrated with the door 14, wherein the external sensor 24 is a motion sensor. The processing unit 25 and the external sensor 24 may be configured to only toggle the light assembly 21 off when motion is detected within a close range so as to avoid unnecessarily disabling the light assembly 21. For example, when someone is simply walking past the storage unit 10. It is also possible for the external sensor 24 to be positioned upwards so as to avoid the movement of pets. It is yet another possibility for the external sensor 24 to be positioned in a discrete location, such as on the handle of the door 14, so as to only detect motion when the human 30 is motioning to open the door 14.

In another embodiment the external sensor 24 is integrated with the storage body 12, wherein the external sensor 24 is a camera. The external sensor 24 records the area surrounding the storage unit 10, while the processing unit 25 analyzes the captured frames to determine if a human 30 is approaching to open the door 14. The processing unit 25 may use software that identifies preset motions such as an arm extending. When the processing unit 25 detects a match with one of the preset motions, the processing unit 25 toggles the light assembly 21 off. It is also possible for the processing unit 25 to utilize artificial intelligence to enhance the detection of someone moving to open the door 14, thus reducing incidents of prematurely disabling the light assembly 21. Furthermore, the artificial intelligence could be used to identify movements associated with specific individuals and reduce the incidents of prematurely disabling the light assembly 21 even more.

In yet another embodiment, the external sensor 24 is integrated with the door 14, wherein the external sensor 24 is a pressure sensor, such as a piezoelectric pressure sensor or a biased switch. More specifically, the external sensor 24 is integrated with the handle of the door 14 or a portion of the door 14 that is normally engaged to open the door 14. In this way, when a human 30 grasps or otherwise engages the handle, the external sensor 24 detects the presence of the human's 30 hand.

The processing unit 25 may also be used to control the timer 23, wherein the processing unit 25 is able to detect when the door 14 has been closed. In one instance the processing unit 25 may be connected to the switch 22 in order to determine when the door 14 has been closed. It is also possible for additional sensors to be provided to allow the processing unit 25 to detect when the door 14 has been closed. When the processing unit 25 detects that the door 14 has been closed, the processing unit 25 resets the timer 23 to go off after the preset time.

In some embodiments the sanitization unit 20 may further comprise a transceiver, wherein the transceiver is electronically connected to the processing unit 25. The transceiver allows the processing unit 25 to communicate with an external device, such as a smartphone or laptop. A control application may be installed on the external device, wherein a user is able to manipulate or monitor settings for the light assembly 21 remotely through the control application. For example, the control application may allow the user to adjust the intensity of the light assembly 21, toggle the light assembly 21 between the on state and the off state, or monitor the electricity consumption of the light assembly 21.

In yet other embodiments, the sanitization unit 20 may further include an additional sensor array for detecting items within the storage unit 10. The additional sensor array is able to detect metrics of the items in the storage unit 10 such as the size of items, the quantity of items, or the location of items within the storage unit 10. The processing unit 25 is electronically connected to the additional sensor array and is able to manipulate the light assembly 21 according to the readings of the sensor array. For example, if a lower quantity of items is being stored, then the processing unit 25 can lessen the intensity of the light assembly 21. As another example, if items are only being stored in a certain section of the storage unit 10, then the processing unit 25 can determine to only actuate a subset of the light assembly 21 and thus increase efficiency of the system.

In other embodiments, the light assembly 21 may comprise one or more operable mounts, wherein one or more bulbs or light emitting diodes are connected to each of the operable mounts. The operable mounts may allow for simple movement of the bulbs or light emitting diodes, such as a pivoting motion, or more advanced motion, such as moving along a track, wherein the bulbs or light emitting diodes can be relocated within the storage unit 10. Each of the operable mounts is electronically connected to the processing unit 25 such that the processing unit 25 may adjust the direction of the light that is emitted. In this way, the light assembly 21 can be targeted to specific regions of the storage unit 10. This also allows the light assembly 21 to be used in a scanning manner, wherein the number of light units can be reduced. For example, instead of a light unit being mounted on each side of the storage unit 10, a single light unit can be mounted to a track that runs across the storage unit 10. The single light unit can then be moved side to side in order to irradiate both sides of the storage unit 10.

An important version of the invention can be fairly described as a perishable storage unit with means for sanitizing food stuffs contained therein. The perishable storage unit has a means for sanitizing food stuffs comprising, among other parts, a storage unit. The storage unit comprising a storage body, a door, and a cooling system, similar to common refrigerators in some embodiments. The door being hinged to the storage body, wherein the door can be pivoted between a closed position and an open position. The cooling system being integrated with the storage body and configured to maintain a cooling temperature when the door is in the closed position such as with a thermostat. A sanitation unit being integrated within the storage body. The sanitation unit comprising a light assembly and a switch. The light assembly being electrically connected to the switch, wherein the light assembly can be toggled between an on state and an off state. The switch being integrated with a peripheral edge of the storage unit. The door engaging the switch in the closed position. The light assembly being toggled to the off state when the door is disengaged from the switch (open door). The light assembly being toggled to the on state when the door is engaged into the switch (closed door) and the light assembly being configured to emit ultraviolet light in the on state.

Optionally, the perishable storage unit further comprises a timer. The timer being electrically connected with the light assembly. The timer being configured to toggle the light assembly from the on state to the off state after a preset duration of time. Optionally, the sanitation unit also includes an external sensor and a processing unit being configured to detect the presence of a human. The processing unit being electronically connected to the external sensor and the light assembly. The processing unit toggling the light assembly to the off state when the presence of the human is detected. Optionally, the external sensor is integrated with the door. Optionally, the external sensor is integrated with the storage body. Optionally, the external sensor is a motion sensor. Optionally, the external sensor is a pressure sensor. Optionally, the external sensor is a camera.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

I/we claim:

1. A perishable storage unit with means for sanitizing food stuffs, the perishable storage unit with means for sanitizing food stuffs comprising:
a storage unit;
the storage unit comprising a storage body, a door, and a cooling system;
the door being hinged to the storage body, wherein the door can be pivoted between a closed position and an open position;
the cooling system being integrated with the storage body and configured to maintain a cooling temperature when the door is in the closed position;
a sanitation unit being integrated within the storage body;
the sanitation unit comprising a light assembly and a switch;
the light assembly being electrically connected to the switch, wherein the light assembly can be toggled between an on state and an off state;
the switch being integrated with a peripheral edge of the storage unit;
the door engaging the switch in the closed position;
the light assembly being toggled to the off state when the door is disengaged from the switch;
the light assembly being toggled to the on state when the door is engaged into the switch; and
the light assembly being configured to emit ultraviolet light in the on state.

2. The perishable storage unit with means for sanitizing food stuffs as claimed in claim 1 further comprises:
a timer;
the timer being electrically connected with the light assembly; and
the timer being configured to toggle the light assembly from the on state to the off state after a preset duration of time.

3. The perishable storage unit with means for sanitizing food stuffs as claimed in claim 1 further comprises:
the sanitation unit comprising an external sensor and a processing unit being configured to detect the presence of a human;
the processing unit being electronically connected to the external sensor and the light assembly; and
the processing unit toggling the light assembly to the off state when the presence of the human is detected.

4. The perishable storage unit with means for sanitizing food stuffs as claimed in claim 3, wherein the external sensor is integrated with the door.

5. The perishable storage unit with means for sanitizing food stuffs as claimed in claim 3, wherein the external sensor is integrated with the storage body.

6. The perishable storage unit with means for sanitizing food stuffs as claimed in claim 3, wherein the external sensor is a motion sensor.

7. The perishable storage unit with means for sanitizing food stuffs as claimed in claim 3, wherein the external sensor is a pressure sensor.

8. The perishable storage unit with means for sanitizing food stuffs as claimed in claim 3, wherein the external sensor is a camera.
